(19) United States
(12) Patent Application Publication
(10) Pub. No.: US 2022/0206786 A1
(43) Pub. Date: Jun. 30, 2022

(54) CODE LIBRARY SELECTION MANAGEMENT

(71) Applicant: International Business Machines Corporation, Armonk, NY (US)

(72) Inventors: Bruno Silva, São Paulo (BR); Marco Aurelio Stelmar Netto, São Paulo (BR); Renato Luiz de Freitas Cunha, São Paulo (BR); Nelson Mimura Gonzalez, White Plains, NY (US)

(73) Assignee: International Business Machines Corporation, Armonk, NY (US)

(21) Appl. No.: 17/137,816

(22) Filed: Dec. 30, 2020

(51) Int. Cl. G06F 8/71; G06F 8/75; G06F 11/36; G06F 16/2457; G06F 16/2455; G06Q 30/04

(52) U.S. Cl. CPC G06F 8/71; G06F 8/75; G06F 11/3688; G06Q 30/04; G06F 16/24578; G06F 16/2455; G06F 11/3692

(57) ABSTRACT

An embodiment includes executing a querying process that searches for candidate code libraries to replace a current library in a software application. The embodiment also includes receiving a search result from the querying process, wherein the search result includes a set of candidate code libraries. The embodiment also includes identifying a top candidate code library as a highest ranking code library of the set of candidate code libraries based on predetermined metrics. The embodiment also includes generating a revised software application from the original software application, the generating comprising replacing the current library in the original software application with the top candidate code library.

### BACKGROUND

The present invention relates generally to the field of information processing. More particularly, the present invention relates generally to a software program development tool, method, and apparatus in a data processing system to a method, system, and computer program product for code library selection management.

A well-known and widely used method of developing a software application is to organize the source code into functions. Each function can be thought of as a building block that performs a specific task any time that task is needed by the application. In practice, a function is a block of code that can be called by the application and executed over and over. This allows a developer to write source code for a specific task one time, even for a task that may be repeated many times, rather than having to repeat the same source code in each part of the application where it might be needed.

When writing or making changes to an application to provide new or unique functionality, a developer may need to take the time to write and test new, original, and unique source code. However, writing source code for more complex functionality can be time consuming and expensive. For these and other reasons, developers often will instead use third-party source code libraries (or simply code libraries) to provide the desired functionality rather than write the functions themselves. This practice has grown in popularity for several reasons, such as reducing time to market or lowering development costs.

Code libraries are widely available from various sources, including public and restricted code repositories. A code repository is typically a searchable, categorized, and/or Internet-accessible location that users may access to browse, search, and download source or compiled library code. Uses of code repositories may include open source projects, proprietary development projects, and/or projects that create libraries for later use. A code library is a collection of resources used to develop software. Such resources may include pre-written code and subroutines, classes, values, or type specifications. Code libraries may contain program code and/or data that provide services to independent programs. Such an implementation allows for program code and/or data to be shared and changed in a modular fashion.

Many libraries are in constant development, and release updates from time to time that fix defects, patch vulnerabilities, or enhance features. Conversely, sometimes libraries are neglected or abandoned by the developers and may fall behind other libraries that provide similar functionality more efficiently, securely, or better in other ways. Therefore, it is considered good practice for software developers to periodically reconsider the libraries their applications depend on, and evaluate whether they should be replaced due to being outdated, subject to vulnerabilities, or having competing libraries that offer more features, better performance, or other advantages. This evaluation is a manual process that can be very time consuming, but nevertheless important because the choice of library can impact several metrics, such as performance, maintenance costs, license costs, storage requirements, energy consumption, and exposure to security vulnerabilities. Library replacement (or library migration) can also be very time consuming and expensive as the process may involve manually resolving compatibility issues arising from the transition.

### SUMMARY

The illustrative embodiments provide for code library selection management. An embodiment includes executing a querying process that searches for candidate code libraries to replace a current library in an original software application. The embodiment also includes receiving a search result from the querying process, wherein the search result includes a set of candidate code libraries. The embodiment also includes identifying a top candidate code library as a highest ranking code library of the set of candidate code libraries based on a predetermined metric. The embodiment also includes generating a revised software application from the original software application, the generating comprising replacing the current library in the original software application with the top candidate code library. Other embodiments of this aspect include corresponding computer systems, apparatus, and computer programs recorded on one or more computer storage devices, each configured to perform the actions of the embodiment.

Other embodiments of this aspect include corresponding computer systems, apparatus, and computer programs recorded on one or more computer storage devices, each configured to perform the actions of the embodiment.

An embodiment includes a computer usable program product. The computer usable program product includes a computer-readable storage medium, and program instructions stored on the storage medium.

An embodiment includes a computer system. The computer system includes a processor, a computer-readable memory, and a computer-readable storage medium, and program instructions stored on the storage medium for execution by the processor via the memory.

### BRIEF DESCRIPTION OF THE DRAWINGS

The novel features believed characteristic of the invention are set forth in the appended claims. The invention itself, however, as well as a preferred mode of use, further objectives and advantages thereof, will best be understood by reference to the following detailed description of the illustrative embodiments when read in conjunction with the accompanying drawings, wherein:

FIG. 1 depicts a cloud computing environment according to an embodiment of the present invention;

FIG. 2 depicts abstraction model layers according to an embodiment of the present invention;

FIG. 3 depicts a block diagram of an exemplary networked computer environment that includes a library management server in accordance with an illustrative embodiment;

FIG. 4 depicts a block diagram of an exemplary library replacement module in accordance with an illustrative embodiment;

FIG. 5 depicts a block diagram of an exemplary code analysis module in accordance with an illustrative embodiment;

FIG. 6 depicts a block diagram of an exemplary troubleshooting history module in accordance with an illustrative embodiment;

FIG. 7 depicts a block diagram of an exemplary code history module code history module in accordance with an illustrative embodiment;

FIG. 8 depicts a flowchart of an example code library selection management process in accordance with an illustrative embodiment;

FIG. 9 depicts a flowchart of an example querying process in accordance with an illustrative embodiment; and

FIG. 10 depicts a flowchart of an example library modification process in accordance with an illustrative embodiment.

### DETAILED DESCRIPTION

There are significant difficulties with using libraries in that a significant amount of effort, knowledge, and experience is needed in order to correctly identify a suitable library from among thousands of stored library files, to understand the performance and coding requirements of the library, and to make any required code adjustments thereto. In addition, the responsibility for using a library typically resides with the programmer or code reviewer, making it difficult to track and enforce library usage. There are similar challenges with developing, updating and expanding existing library databases since there are no standardized mechanisms for generating, vetting, and adding library functions to an existing library knowledge base. In the absence of control procedures for reviewing and validating proposed library additions, an uploaded library file can corrupt or damage the library knowledge base. Thus, while the use of libraries is considered a best practice for software development, the existing solutions for adding library functions to promote library use are extremely difficult at a practical level by virtue of the difficulty in identifying, uploading, adding, adopting, and modifying libraries.

Detailed embodiments of the claimed structures and methods are disclosed herein; however, it can be understood that the disclosed embodiments are merely illustrative of the claimed structures and methods that may be embodied in various forms. This invention may, however, be embodied in many different forms and should not be construed as limited to the exemplary embodiments set forth herein. In the description, details of well-known features and techniques may be omitted to avoid unnecessarily obscuring the presented embodiments.

Embodiments of the present invention relate to the field of computing, and more particularly to automating aspects of updating code libraries in order to reduce the time and expense ordinarily involved and to reduce the chance of problems stemming from human error. The following described exemplary embodiments provide a system, method, and program product to, among other things, locate candidate code libraries to replace an existing code library, detect changes involved in replacing the existing code library with the new code library, and implementing those changes to replace the existing code library with the new code library.

In exemplary embodiments, a library selection and management process receives source code for an original software application, for example from a user or from an IDE. In some embodiments, the library selection and management process analyzes the source code of the original software application to find referenced code libraries. In some embodiments, the library selection and management process assembles a list of code libraries referenced by the original software application during the analysis. The library selection and management process then initiates a querying process to search for candidate library replacement options in source code repositories or troubleshooting websites, databases, mailing lists, or other such resources.

In an exemplary embodiment, the library selection and management process consumes data from troubleshooting cloud services and/or consumes data from code management cloud services. In some embodiments, the library selection and management process uses such data for executing a querying process that searches for candidate code libraries to replace a current library in an original software application.

For example, in some embodiments, the library selection and management process executes a querying process that comprises searching one or more code troubleshooting services to identify information, such as discussions, blog posts, or other types of information, regarding changes made to source code to implement the candidate code library. In some such embodiments, the library selection and management process uses natural language processing to identify the information associated with the changes made to source code to implement the candidate code library.

Alternatively, in some embodiments, the library selection and management process executes a querying process that comprises searching one or more code management systems to identify source code that references a candidate code library, and detects an indication of an explanation of changes to the identified source code that were made to implement the candidate code library. In some such embodiments, the library selection and management process uses natural language processing to identify the changes.

In an exemplary embodiment, the library selection and management process indicates which library candidates can be used for replacement and performs the replacement of the library if possible and allowed. In some such embodiments, the library selection and management process uses a search result from the querying process that includes a set of candidate code libraries as potential candidates to replace the current code library in the original software application. The library selection and management process then identifies a top candidate code library as a highest ranking code library from among the candidate code libraries returned as search results. For example, in some embodiments, the library selection and management process ranks the candidate code libraries according to how well each candidate code library satisfies one or more specified metrics, and then selects the highest ranking candidate code library as the top candidate code library.

The library selection and management process then generates a revised software application from the original software application by performing a replacement process that results in replacing the current code library in the original software application with the top candidate code library. In some embodiments, library selection and management process performs a replacement process that includes searching for expositive source code that has a revision history that is instructive for replacing a code library with the top candidate code library. In some embodiments, the searching includes performing a text search of one or more source code repositories for source code that includes the top candidate code library. For example, many public software repositories include search functionality that allows for performing the source code stored in the repository for a particular word or phrase. Many such repositories also store revision histories for the source code. In some embodiments, when the library selection and management process locates source code that includes the top candidate code library, the library selection and management process searches the revision history of that source code for a revision that involved replacing a code library with the top candidate code library.

In some embodiments, when the library selection and management process locates source code that satisfies this criteria, the library selection and management process uses this source code as expositive source code. The library selection and management process identifies the “before and after” versions of the expositive source code, which are the versions of the expositive source code immediately before and after the top candidate code library replaced another code library. For example, in some embodiments, the library selection and management process generates before and after abstract syntax trees—one for each of the before and after versions of the expositive source code—and evaluates the differences between the two abstract syntax trees. In some embodiments, if complete source code and input parameters are available for each of the before and after versions of the expositive source code, the library selection and management process execute the before version of the source code and executes the after version of the source code and tracks the input parameters during the execution of the two versions of the expositive source code to identify differences between the before and after versions of the expositive source code. In some embodiments, the library selection and management process assembles the differences found during the analysis of the before and after versions of the expositive source code and stores them as library replacement rules in a database for later use. In some embodiments, the library selection and management process then modifies the source code of the original software application (and thereby generates a revised software application) according to differences found during the analysis of the before and after versions of the expositive source code and input variables.

In an exemplary embodiment, the library selection and management process analyzes source code and runtime variables. For example, in some embodiments, the library selection and management process receives the revised software application from the library selection and management process for analysis and final implementation. In some embodiments, the library selection and management process determines whether unit tests are available for the original and revised versions of the software application. If so, then the library selection and management process executes both versions of the software application in order to get respective sets of unit test results, and compares the two sets of test results in order to evaluate whether the code library replacement process was successfully completed.

In some embodiments, the library selection and management process generates a modification report that includes a summary of modifications made to source code in order to accommodate the replacement of an old code library with the top candidate code library. In some such embodiments, the library selection and management process includes results of the unit tests if available in the modification report. In some such embodiments, the library selection and management process then outputs the modification report for review by a user. In some such embodiments, the library selection and management process also instructs the user to provide final confirmation before the modifications in the modification report will be finalized (e.g., implemented in the production version). In some such embodiments, the library selection and management process then awaits an indication of whether the user accepts or rejects the revised software application. In some embodiments, if the user accepts the revised software application, the library selection and management process takes further steps that are implementation-specific to commit the modifications to a runtime or production version of the source code for the software application. Alternatively, in some embodiments, the library selection and management process provides the revised source code to the user for further implementation processing. In some embodiments, once the user has accepted or rejected the revised software application, the library selection and management process sends a feedback request to the user requesting a reason for the user's decision to accept or reject the revised software application.

In some embodiments, if the user rejects the revised software application, the library selection and management process repeats the process using a different candidate code library. In some such embodiments, the library selection and management process continues to repeat this using different candidate code libraries until a revised version of the software application is accepted by the user, or until no further candidate code libraries are available or the user instructs the library selection and management process to halt the process.

For the sake of clarity of the description, and without implying any limitation thereto, the illustrative embodiments are described using some example configurations. From this disclosure, those of ordinary skill in the art will be able to conceive many alterations, adaptations, and modifications of a described configuration for achieving a described purpose, and the same are contemplated within the scope of the illustrative embodiments.

Furthermore, simplified diagrams of the data processing environments are used in the figures and the illustrative embodiments. In an actual computing environment, additional structures or component that are not shown or described herein, or structures or components different from those shown but for a similar function as described herein may be present without departing the scope of the illustrative embodiments.

Furthermore, the illustrative embodiments are described with respect to specific actual or hypothetical components only as examples. The steps described by the various illustrative embodiments can be adapted for providing explanations for decisions made by a machine-learning classifier model, for example

Any specific manifestations of these and other similar artifacts are not intended to be limiting to the invention. Any suitable manifestation of these and other similar artifacts can be selected within the scope of the illustrative embodiments.

The examples in this disclosure are used only for the clarity of the description and are not limiting to the illustrative embodiments. Any advantages listed herein are only examples and are not intended to be limiting to the illustrative embodiments. Additional or different advantages may be realized by specific illustrative embodiments. Furthermore, a particular illustrative embodiment may have some, all, or none of the advantages listed above.

Furthermore, the illustrative embodiments may be implemented with respect to any type of data, data source, or access to a data source over a data network. Any type of data storage device may provide the data to an embodiment of the invention, either locally at a data processing system or over a data network, within the scope of the invention. Where an embodiment is described using a mobile device, any type of data storage device suitable for use with the mobile device may provide the data to such embodiment, either locally at the mobile device or over a data network, within the scope of the illustrative embodiments.

The illustrative embodiments are described using specific code, contrastive explanations, computer readable storage medium, high-level features, historical data, designs, architectures, protocols, layouts, schematics, and tools only as examples and are not limiting to the illustrative embodiments. Furthermore, the illustrative embodiments are described in some instances using particular software, tools, and data processing environments only as an example for the clarity of the description. The illustrative embodiments may be used in conjunction with other comparable or similarly purposed structures, systems, applications, or architectures. An illustrative embodiment may be implemented in hardware, software, or a combination thereof.

The examples in this disclosure are used only for the clarity of the description and are not limiting to the illustrative embodiments. Additional data, operations, actions, tasks, activities, and manipulations will be conceivable from this disclosure and the same are contemplated within the scope of the illustrative embodiments.

Any advantages listed herein are only examples and are not intended to be limiting to the illustrative embodiments. Additional or different advantages may be realized by specific illustrative embodiments. Furthermore, a particular illustrative embodiment may have some, all, or none of the advantages listed above.

It is to be understood that although this disclosure includes a detailed description on cloud computing, implementation of the teachings recited herein are not limited to a cloud computing environment. Rather, embodiments of the present invention are capable of being implemented in conjunction with any other type of computing environment now known or later developed.

Cloud computing is a model of service delivery for enabling convenient, on-demand network access to a shared pool of configurable computing resources (e.g., networks, network bandwidth, servers, processing, memory, storage, applications, virtual machines, and services) that can be rapidly provisioned and released with minimal management effort or interaction with a provider of the service. This cloud model may include at least five characteristics, at least three service models, and at least four deployment models.

Characteristics are as follows:

On-demand self-service: a cloud consumer can unilaterally provision computing capabilities, such as server time and network storage, as needed automatically without requiring human interaction with the service's provider.

Broad network access: capabilities are available over a network and accessed through standard mechanisms that promote use by heterogeneous thin or thick client platforms (e.g., mobile phones, laptops, and personal digital assistants (PDAs)s).

Resource pooling: the provider's computing resources are pooled to serve multiple consumers using a multi-tenant model, with different physical and virtual resources dynamically assigned and reassigned according to demand. There is a sense of location independence in that the consumer generally has no control or knowledge over the exact location of the provided resources but may be able to specify location at a higher level of abstraction (e.g., country, state, or datacenter).

Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time.

Measured service: cloud systems automatically control and optimize resource use by leveraging a metering capability at some level of abstraction appropriate to the type of service (e.g., storage, processing, bandwidth, and active user accounts). Resource usage can be monitored, controlled, and reported, providing transparency for both the provider and consumer of the utilized service.

Service Models are as follows:

Software as a Service (SaaS): the capability provided to the consumer is to use the provider's applications running on a cloud infrastructure. The applications are accessible from various client devices through a thin client interface such as a web browser (e.g., web-based e-mail). The consumer does not manage or control the underlying cloud infrastructure including network, servers, operating systems, storage, or even individual application capabilities, with the possible exception of limited user-specific application configuration settings.

Platform as a Service (PaaS): the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations.

Infrastructure as a Service (IaaS): the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (e.g., host firewalls).

Deployment Models are as follows:

Private cloud: the cloud infrastructure is operated solely for an organization. It may be managed by the organization or a third party and may exist on-premises or off-premises.

Community cloud: the cloud infrastructure is shared by several organizations and supports a specific community that has shared concerns (e.g., mission, security requirements, policy, and compliance considerations). It may be managed by the organizations or a third party and may exist on-premises or off-premises.

Public cloud: the cloud infrastructure is made available to the general public or a large industry group and is owned by an organization selling cloud services.

Hybrid cloud: the cloud infrastructure is a composition of two or more clouds (private, community, or public) that remain unique entities but are bound together by standardized or proprietary technology that enables data and application portability (e.g., cloud bursting for load-balancing between clouds).

A cloud computing environment is service oriented with a focus on statelessness, low coupling, modularity, and semantic interoperability. At the heart of cloud computing is an infrastructure that includes a network of interconnected nodes.

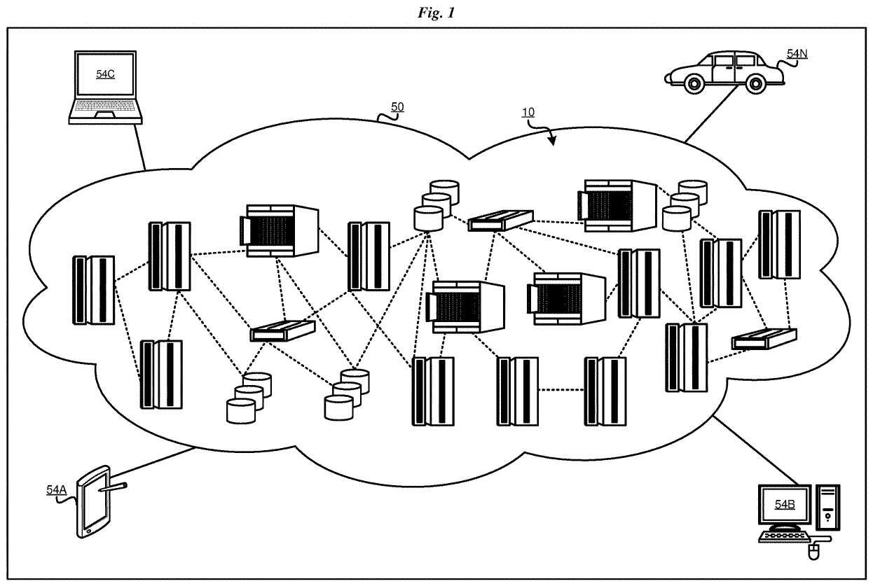

Referring now to FIG. 1, illustrative cloud computing environment 50 is depicted. As shown, cloud computing environment 50 includes one or more cloud computing nodes 10 with which local computing devices used by cloud consumers, such as, for example, personal digital assistant (PDA) or cellular telephone 54A, desktop computer 54B, laptop computer 54C, and/or automobile computer system 54N may communicate. Nodes 10 may communicate with one another. They may be grouped (not shown) physically or virtually, in one or more networks, such as Private, Community, Public, or Hybrid clouds as described hereinabove, or a combination thereof. This allows cloud computing environment 50 to offer infrastructure, platforms and/or software as services for which a cloud consumer does not need to maintain resources on a local computing device. It is understood that the types of computing devices 54A-N shown in FIG. 1 are intended to be illustrative only and that computing nodes 10 and cloud computing environment 50 can communicate with any type of computerized device over any type of network and/or network addressable connection (e.g., using a web browser).

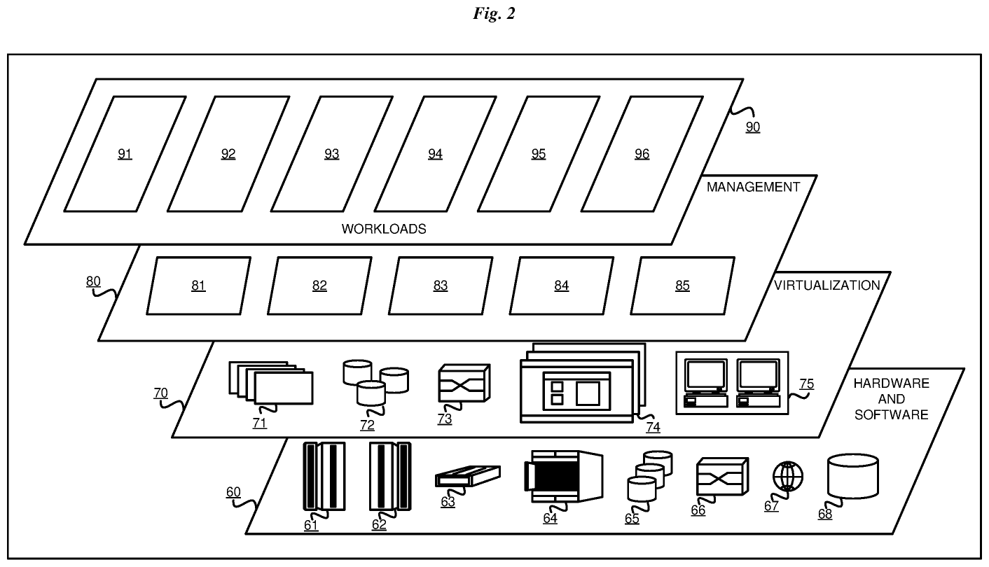

Referring now to FIG. 2, a set of functional abstraction layers provided by cloud computing environment 50 (FIG. 1) is shown. It should be understood in advance that the components, layers, and functions shown in FIG. 2 are intended to be illustrative only and embodiments are not limited thereto. As depicted, the following layers and corresponding functions are provided:

Hardware and software layer 60 includes hardware and software components. Examples of hardware components include: mainframes 61; RISC (Reduced Instruction Set Computer) architecture based servers 62; servers 63; blade servers 64; storage devices 65; and networks and networking components 66. In some embodiments, software components include network application server software 67 and database software 68.

Virtualization layer 70 provides an abstraction layer from which the following examples of virtual entities may be provided: virtual servers 71; virtual storage 72; virtual networks 73, including virtual private networks; virtual applications and operating systems 74; and virtual clients 75.

In one example, management layer 80 may provide the functions described below. Resource provisioning 81 provides dynamic procurement of computing resources and other resources that are utilized to perform tasks within the cloud computing environment. Metering and Pricing 82 provide cost tracking as resources are utilized within the cloud computing environment, and billing or invoicing for consumption of these resources. In one example, these resources may include application software licenses. Security provides identity verification for cloud consumers and tasks, as well as protection for data and other resources. User portal 83 provides access to the cloud computing environment for consumers and system administrators. Service level management 84 provides cloud computing resource allocation and management such that required service levels are met. Service Level Agreement (SLA) planning and fulfillment 85 provide pre-arrangement for, and procurement of, cloud computing resources for which a future requirement is anticipated in accordance with an SLA.

Workloads layer 90 provides examples of functionality for which the cloud computing environment may be utilized. Examples of workloads and functions which may be provided from this layer include: mapping and navigation 91; software development and lifecycle management 92; virtual classroom education delivery 93; data analytics processing 94; transaction processing 95; and code library replacement management function 96. The code library replacement management function 96 may be enabled to analyze a currently used code library in a software application, search for code libraries as candidates for replacing the currently used code library, rank the code libraries returned as the search results according to a user-specified metric, or plurality of metrics, and replace the currently used code library with the top ranked code library from among the search results.

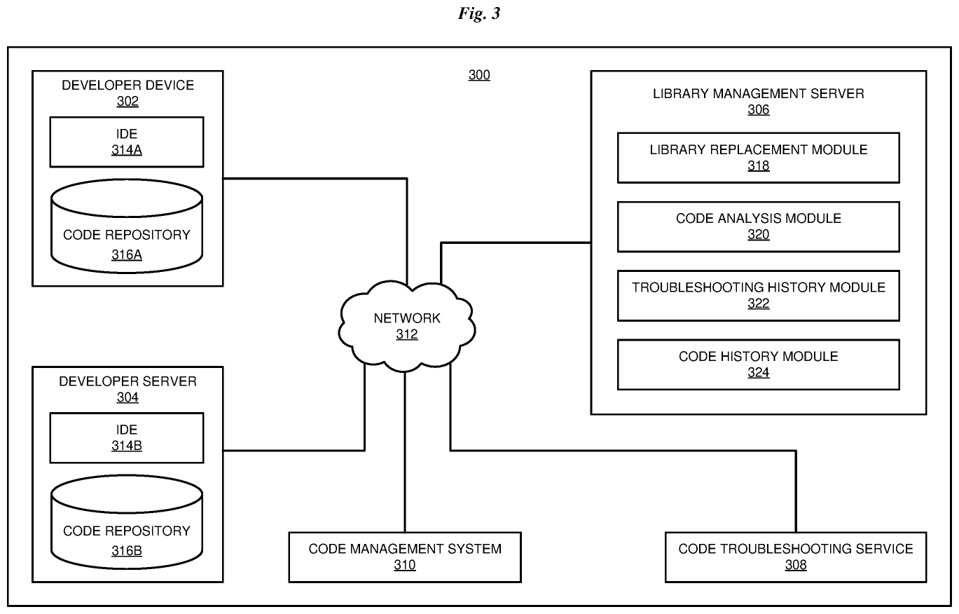

With reference to FIG. 3, this figure depicts a block diagram of an exemplary networked computer environment 300 that includes a library management server 306 in accordance with an illustrative embodiment. By way of example, in some embodiments, library management server 306 is implemented as code library replacement management function 96 in FIG. 2.

In the illustrated embodiment, the networked computer environment 300 includes developer device 302, development server 304, library management server 306, code troubleshooting service 308, and code management system 310 interconnected via a communication network 312. In some embodiments, the developer device 302 and/or the development server 304 include an integrated development environment (IDE) 314A, 314B and a code repository 316A, 316B. In some embodiments, the library management server 306 comprises a library replacement module 318, code analysis module 320, troubleshooting history module 322, and code history module 324. In alternative embodiments, the networked computer environment 300 can include some or all of the functionality described herein but grouped differently into one or more modules. In some embodiments, the functionality described herein is distributed among a plurality of systems, which can include combinations of software and/or hardware based systems, for example Application-Specific Integrated Circuits (ASICs), computer programs, or smart phone applications

Embodiments of the communication network 312 include various types of communication networks, such as a wide area network (WAN), local area network (LAN), a telecommunication network, a wireless network, a public switched network and/or a satellite network. Embodiments of the communication network 312 include connections, such as wire, wireless communication links, or fiber optic cables. FIG. 3 provides only an illustration of one implementation and does not imply any limitations with regard to the environments in which different embodiments may be implemented. Many modifications to the depicted environment may be made based on design and implementation requirements.

In some embodiments, developer device 302 is a computing device (e.g., laptop or a desktop) that is operated by a user to perform development tasks on a software application. In some embodiments, the developer device 302 includes a local IDE 314A and code repository 316A. In alternative embodiments, the developer device 302 allows the user to access and interact with a remote IDE 314B and code repository 316B. In still further embodiments, the developer device 302 interacts with an IDE that includes local IDE 314A components and remote IDE 314B components, and/or interacts with a code repository that includes local code repository 316A components and remote code repository 316B components. In some embodiments, the IDE 314A, 314B comprises a software suite that consolidates basic tools required to write and test software. For example, in some embodiments, the IDE 314A, 314B comprises a text editor, compiler, code libraries, and test platform. In some embodiments, the code repository 316A, 316B comprises a file archive for source code of software, documentation, web pages, and/or other application-related works, accessible either publicly or privately. In some embodiments, the code repository 316A, 316B is used by an open-source software project or multi-developer project to maintain revision and version history, or version control.

In the illustrated embodiment, the library management server 306 receives source code for an original software application, for example from a user or from an IDE 314A, 314B. In some embodiments, the library management server 306 analyzes the source code of the original software application to find referenced code libraries. In some embodiments, the library management server 306 assembles a list of code libraries referenced by the original software application during the analysis. The library management server 306 then initiates a querying process to search for candidate library replacement options in source code repositories, such as code management system 310, or troubleshooting websites, databases, mailing lists, or other such resources, such as code troubleshooting service 308.

In the illustrated embodiment, the troubleshooting history module 322 is a software module that consumes data from troubleshooting cloud services, such as code troubleshooting service 308. The code history module 324 is a software module that consumes data from code management cloud services, such as code management system 310. In some embodiments, the library management server 306 employs troubleshooting history module 322 for searching one or more code troubleshooting services 308 and/or code history module 324 code management system 310 to execute the querying process that searches for candidate code libraries to replace a current library in an original software application.

For example, in some embodiments, the troubleshooting history module 322 executes a querying process that comprises searching one or more code troubleshooting services 308 to identify information, such as discussions, blog posts, or other types of information, regarding changes made to source code to implement the candidate code library. In some such embodiments, the troubleshooting history module 322 uses natural language processing to identify the information associated with the changes made to source code to implement the candidate code library.

Alternatively, in some embodiments, the code history module 324 executes a querying process that comprises searching one or more code management systems 310 to identify source code that references a candidate code library, and detects an indication of an explanation of changes to the identified source code that were made to implement the candidate code library. In some such embodiments, the code history module 324 uses natural language processing to identify the changes.

In the illustrated embodiment, the library replacement module 318 is a software module that indicates which library candidates can be used for replacement and performs the replacement of the library if possible and allowed. In some such embodiments, the library replacement module 318 receives a search result from the querying process that includes a set of candidate code libraries as potential candidates to replace the current code library in the original software application. The library replacement module 318 then identifies a top candidate code library as a highest ranking code library from among the candidate code libraries returned as search results. For example, in some embodiments, the library replacement module 318 ranks the candidate code libraries according to how well each candidate code library satisfies one or more specified metrics, and then selects the highest ranking candidate code library as the top candidate code library.

The library replacement module 318 then generates a revised software application from the original software application by performing a replacement process that results in replacing the current code library in the original software application with the top candidate code library. In some embodiments, library replacement module 318 performs a replacement process that includes searching for expositive source code that has a revision history that is instructive for replacing a code library with the top candidate code library. In some embodiments, the searching includes performing a text search of one or more source code repositories for source code that includes the top candidate code library. For example, many public software repositories include search functionality that allows for performing the source code stored in the repository for a particular word or phrase. Many such repositories also store revision histories for the source code. In some embodiments, when the library replacement module 318 locates source code that includes the top candidate code library, the library replacement module 318 searches the revision history of that source code for a revision that involved replacing a code library with the top candidate code library.

In some embodiments, when the library replacement module 318 locates source code that satisfies this criteria, the library replacement module 318 uses this source code as expositive source code. The library replacement module 318 identifies the “before and after” versions of the expositive source code, which are the versions of the expositive source code immediately before and after the top candidate code library replaced another code library. For example, in some embodiments, the library replacement module 318 generates before and after abstract syntax trees—one for each of the before and after versions of the expositive source code—and evaluates the differences between the two abstract syntax trees. In some embodiments, if complete source code and input parameters are available for each of the before and after versions of the expositive source code, the library replacement module 318 executes the before version of the source code and executes the after version of the source code and tracks the input parameters during the execution of the two versions of the expositive source code to identify differences between the before and after versions of the expositive source code. In some embodiments, the library replacement module 318 assembles the differences found during the analysis of the before and after versions of the expositive source code and stores them as library replacement rules in a database for later use. In some embodiments, the library replacement module 318 then modifies the source code of the original software application (and thereby generates a revised software application) according to differences found during the analysis of the before and after versions of the expositive source code and input variables.

In the illustrated embodiment, the code analysis module 320 is a software module that analyzes source code and runtime variables. For example, in some embodiments, the code analysis module 320 receives the revised software application from the library replacement module 318 for analysis and final implementation. In some embodiments, the code analysis module 320 determines whether unit tests are available for the original and revised versions of the software application. If so, then the code analysis module 320 executes both versions of the software application in order to get respective sets of unit test results, and compares the two sets of test results in order to evaluate whether the code library replacement process was successfully completed by the library replacement module 318.

In some embodiments, the code analysis module 320 generates a modification report that includes a summary of modifications made to source code in order to accommodate the replacement of an old code library with the top candidate code library. In some such embodiments, the code analysis module 320 includes results of the unit tests if available in the modification report. In some such embodiments, the code analysis module 320 then outputs the modification report for review by a user. In some such embodiments, the code analysis module 320 also instructs the user to provide final confirmation before the modifications in the modification report will be finalized (e.g., implemented in the production version). In some such embodiments, the code analysis module 320 then awaits an indication of whether the user accepts or rejects the revised software application. In some embodiments, if the user accepts the revised software application, the library management server 306 takes further steps that are implementation-specific to commit the modifications to a runtime or production version of the source code for the software application. Alternatively, in some embodiments, the library management server 306 provides the revised source code to the user for further implementation processing. In some embodiments, once the user has accepted or rejected the revised software application, the code analysis module 320 sends a feedback request to the user requesting a reason for the user's decision to accept or reject the revised software application.

In some embodiments, if the user rejects the revised software application, the library management server 306 repeats the process using a different candidate code library. In some such embodiments, the library management server 306 continues to repeat this using different candidate code libraries until a revised version of the software application is accepted by the user, or until no further candidate code libraries are available or the user instructs the library management server 306 to halt the process.

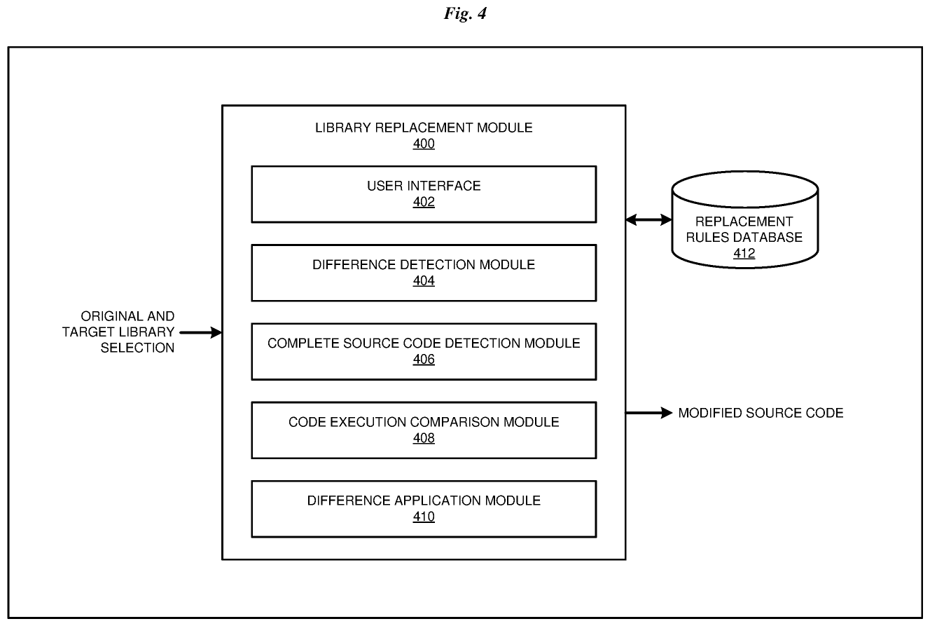

With reference to FIG. 4, this figure depicts a block diagram of an exemplary library replacement module 400 in accordance with an illustrative embodiment. In an exemplary embodiment, the library replacement module 400 is an example of the library replacement module 318 of FIG. 3.

In the illustrated embodiment, the library replacement module 400 includes a user interface 402, a difference detection module 404, a complete source code detection module 406, a code execution comparison module 408, and a difference application module 410. The library replacement module 400 is in communication with a replacement rules database 412, which may include local and/or remote data storage. In alternative embodiments, the library replacement module 400 can include some or all of the functionality described herein but grouped differently into one or more modules. In some embodiments, the functionality described herein is distributed among a plurality of systems, which can include combinations of software and/or hardware based systems, for example Application-Specific Integrated Circuits (ASICs), computer programs, or smart phone applications.

In the illustrated embodiment, the library replacement module 400 is a software module that indicates which library candidates can be used for replacement and performs the replacement of the library if possible and allowed. In some such embodiments, the user interface 402 receives a search result from the querying process that includes a set of candidate code libraries as potential candidates to replace the current code library in the original software application. In some embodiments, the library replacement module 400 also receives an indication of a top candidate code library as a highest ranking code library from among the candidate code libraries. Alternatively, in some embodiments, the library replacement module 400 identifies a top candidate code library as a highest ranking code library from among the candidate code libraries returned as search results. For example, in some embodiments, the library replacement module 400 ranks the candidate code libraries according to how well each candidate code library satisfies one or more specified metrics, and then selects the highest ranking candidate code library as the top candidate code library.

The library replacement module 400 then generates a revised software application from the original software application by performing a replacement process that results in replacing the current code library in the original software application with the top candidate code library. In some embodiments, difference detection module 404 performs a replacement process that includes searching for expositive source code that has a revision history that is instructive for replacing a code library with the top candidate code library. In some embodiments, the searching includes performing a text search of one or more source code repositories for source code that includes the top candidate code library. For example, many public software repositories include search functionality that allows for performing the source code stored in the repository for a particular word or phrase. Many such repositories also store revision histories for the source code. In some embodiments, when the difference detection module 404 locates source code that includes the top candidate code library, the difference detection module 404 searches the revision history of that source code for a revision that involved replacing a code library with the top candidate code library.

In some embodiments, when the difference detection module 404 locates source code that satisfies this criteria, the difference detection module 404 uses this source code as expositive source code. The difference detection module 404 identifies the “before and after” versions of the expositive source code, which are the versions of the expositive source code immediately before and after the top candidate code library replaced another code library. For example, in some embodiments, the difference detection module 404 generates before and after abstract syntax trees—one for each of the before and after versions of the expositive source code—and evaluates the differences between the two abstract syntax trees. In some embodiments, the complete source code detection module 406 the determines if complete source code and input parameters are available for each of the before and after versions of the expositive source code, for example using NLP and/or by attempting to compile the before and after versions of the source code. For example, in some embodiments, the complete source code detection module 406 uses the ability to successfully execute or compile the source code as an indication that the complete source code and input parameters are available. In some embodiments, if the complete source code and input parameters are available, the complete source code detection module 406 issues a notification to the code execution comparison module 408 indicating that the complete source code and input parameters are available. In response, the code execution comparison module 408 executes the before version of the source code and executes the after version of the source code and tracks the input parameters during the execution of the two versions of the expositive source code to identify differences between the before and after versions of the expositive source code. In some embodiments, the code execution comparison module 408 assembles the differences found during the analysis of the before and after versions of the expositive source code and stores them as library replacement rules in the replacement rules database 412. In some embodiments, the code execution comparison module 408 notifies the difference application module 410 of the availability of the library replacement rules. In response, the difference application module 410 modifies the source code of the original software application (and thereby generates a revised software application) according to the library replacement rules generated by the code execution comparison module 408.

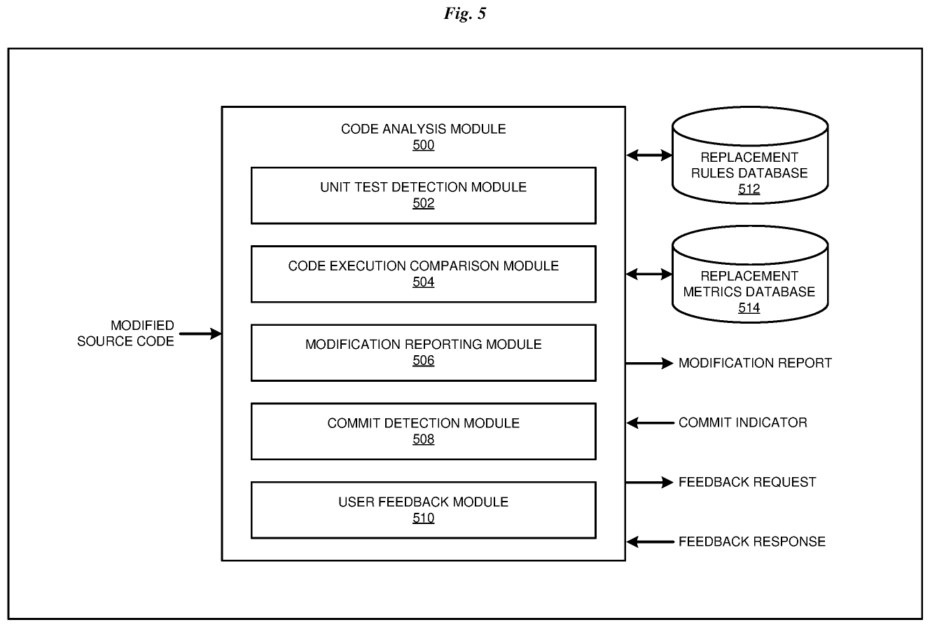

With reference to FIG. 5, this figure depicts a block diagram of an exemplary code analysis module 500 in accordance with an illustrative embodiment. In an exemplary embodiment, the code analysis module 500 is an example of the code analysis module 500 of FIG. 3.

In the illustrated embodiment, the code analysis module 500 includes a code analysis module 500, a unit test detection module 502, a code execution comparison module 504, a modification reporting module 506, a commit detection module 508, a user feedback module 510, a replacement rules database 512, and a replacement metrics database 514. The code analysis module 500 is in communication with a replacement rules database 512 and a replacement metrics database 514, which may include local and/or remote data storage. In alternative embodiments, the code analysis module 500 can include some or all of the functionality described herein but grouped differently into one or more modules. In some embodiments, the functionality described herein is distributed among a plurality of systems, which can include combinations of software and/or hardware based systems, for example Application-Specific Integrated Circuits (ASICs), computer programs, or smart phone applications.

In the illustrated embodiment, the code analysis module 500 is a software module that analyzes source code and runtime variables. For example, in some embodiments, the code analysis module 500 receives the revised software application from a library replacement module (e.g., the library replacement module 318 of FIG. 3) for analysis and final implementation. In some embodiments, the unit test detection module 502 determines whether unit tests are available for the original and revised versions of the software application. For example, in some embodiments, the unit test detection module 502 uses NLP to evaluate the source code and detect unit tests. If the unit test detection module 502 detects unit tests, it notifies the code execution comparison module 504. In response, the code execution comparison module 504 executes both versions of the software application in order to get respective sets of unit test results, and compares the two sets of test results in order to evaluate whether the code library replacement process was successfully completed in the revised software application.

Once this comparison is complete, the code execution comparison module 504 notifies the modification reporting module 506 of the completion of the comparison and the comparison results. In response, the modification reporting module 506 generates a modification report that includes a summary of modifications made to source code in order to accommodate the replacement of an old code library with the top candidate code library. In some such embodiments, the modification reporting module 506 includes results of the unit tests if available in the modification report. In some embodiments, the modification report includes information that the modification reporting module 506 retrieves from the replacement rules database 512 associated with steps taken to revise the source code to arrive at the revised software application. In some embodiments, the modification report includes information that the modification reporting module 506 retrieves from the replacement metrics database 514 associated with metrics achieved by the revised software application. In some embodiments, the modification reporting module 506 then outputs the modification report for review by a user. In some such embodiments, the modification reporting module 506 also instructs the user to provide final confirmation before the modifications in the modification report will be finalized (e.g., implemented in the production version). In some such embodiments, the commit detection module 508 detects an indication of whether the user accepts or rejects the revised software application. For example, in some embodiments, the commit detection module 508 receives an input from the user indicating acceptance or rejection of the revised software application. Alternatively, in some embodiments, the commit detection module 508 detects action by the user to further implement the revised software application, for example by committing the changes to a development or production version of the software application. In some embodiments, the commit detection module 508 notifies the 510 regarding the revised software application and the decision by the user to accept or reject the revised software application. In some embodiments, the user feedback module 510 sends a feedback request to the user requesting a reason for the user's decision to accept or reject the revised software application.

Referring again to FIG. 3, in some embodiments, the library management server 306 analyzes the source code of the original software application to find referenced code libraries. In some embodiments, the library management server 306 assembles a list of code libraries referenced by the original software application during the analysis. The library management server 306 then initiates a series of querying processes for each code library on the list. In some embodiments, the user may remove code libraries from the list, for example in situations where the user desires to keep certain code libraries. In some embodiments, the library management server 306 starts with one of the code libraries on the list by issuing information regarding the code library being evaluated to one or both of the troubleshooting history module 322 and the code history module 324 to search for candidate library replacement options. Once processing of that code library is complete, the library management server 306 proceeds to the next code library on the list until they have all been processed for replacement. Alternatively, the library management server 306 may process one or more of the code libraries in parallel.

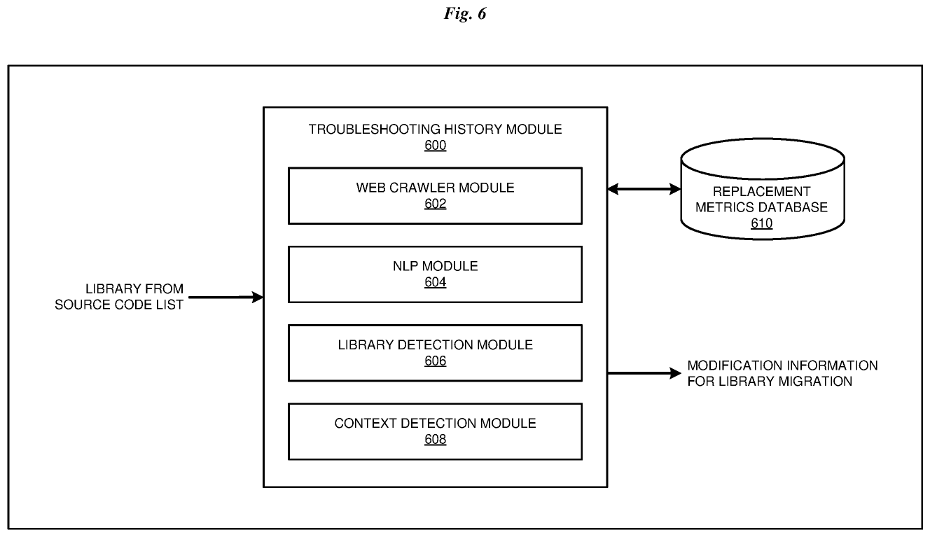

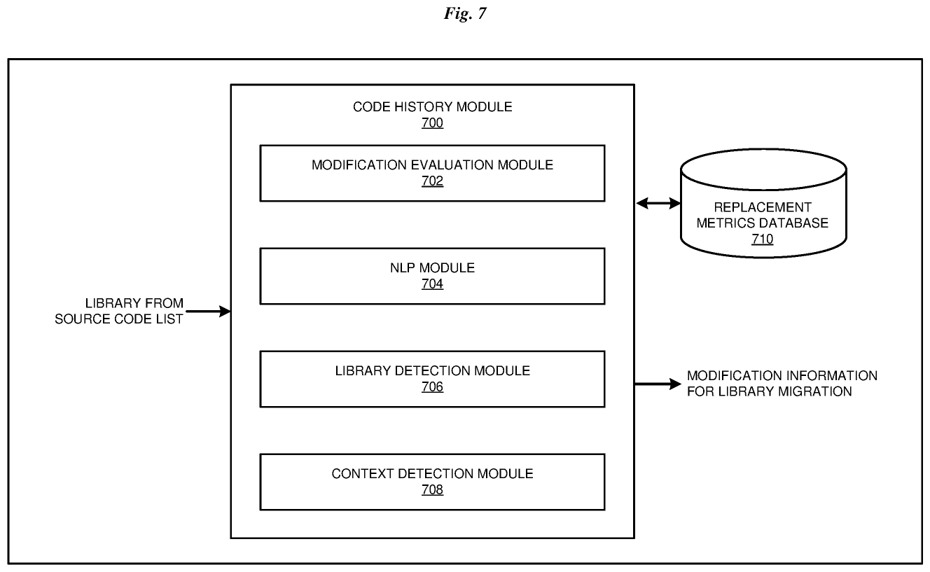

In some embodiments, the decision by the library management server 306 to use the troubleshooting history module 322 and/or the code history module 324 may be made based on user preferences. In some embodiments, the library management server 306 may use one the troubleshooting history module 322 and the code history module 324 first, and if unsuccessful, then uses the other of the troubleshooting history module 322 and the code history module 324. FIG. 6 shows troubleshooting history module 600 as an exemplary embodiment of the troubleshooting history module 322, and FIG. 7 shows code history module 700 as an exemplary embodiment of the code history module 324.

With reference to FIG. 6, this figure depicts a block diagram of an exemplary troubleshooting history module 600 in accordance with an illustrative embodiment. In an exemplary embodiment, the troubleshooting history module 600 is an example of the troubleshooting history module 322 of FIG. 3.

In the illustrated embodiment, the troubleshooting history module 600 includes a web crawler module 602, an NLP module 604, a library detection module 606, and a context detection module 608. The troubleshooting history module 600 is in communication with a replacement metrics database 610, which may include local and/or remote data storage. In alternative embodiments, the troubleshooting history module 600 can include some or all of the functionality described herein but grouped differently into one or more modules. In some embodiments, the functionality described herein is distributed among a plurality of systems, which can include combinations of software and/or hardware based systems, for example Application-Specific Integrated Circuits (ASICs), computer programs, or smart phone applications.

In the illustrated embodiment, the troubleshooting history module 600 is a software module that consumes data from troubleshooting cloud services (e.g., generally illustrated as code troubleshooting service 308 of FIG. 3). In some embodiments, the troubleshooting history module 600 accesses the troubleshooting cloud services to execute the querying process that searches for candidate code libraries to replace a current library in an original software application. In some embodiments, the troubleshooting history module 600 retrieves replacement metrics from the replacement metrics database 610 to use for evaluating and ranking candidate code library replacements found by the querying process.

In the illustrated embodiment, the web crawler module 602 receives information regarding the code library being evaluated from the library management server 306 of FIG. 3. In some embodiments, the information includes a search query. Alternatively, in some embodiments, the web crawler module 602 generates a search query from the information using NLP and/or a series of rules for generating a query from the received information. In some embodiments, the web crawler module 602 conducts a search for a candidate code libraries as candidates for replacing the code library being evaluated. In some embodiments, the web crawler module 602 searches a designated network, such as the Internet, a private intranet, or a specified list of network locations, IP addresses, or URLs. In some embodiments, the web crawler module 602 searches for information regarding the code library being evaluated to detect information related to replacing that code library. In some embodiments, the 602 searches for discussions, blog posts, or other types of information to find information related to candidate code libraries that have potential for replacing the code library being evaluated. In some embodiments, when the web crawler module 602 finds information that may contain candidate code library information, it sends this information to the NLP module 604. In response, the NLP module 604 processes the information in conjunction with the library detection module 606 and the context detection module 608. The library detection module 606 uses the NLP module 604 to identify a candidate replacement library in the information. The context detection module 608 uses the NLP module 604 to confirm that the information includes a description of a library change to implement the candidate code library. In some embodiments, the context detection module 608 also detects information regarding changes to metrics achieved by implementing the candidate code library and stores this information associated with the candidate code library in the replacement metrics database 610.

In some embodiments, the troubleshooting history module 600 outputs each candidate code library for library migration, for example to the library replacement module 318 of FIG. 3. In some embodiments, the troubleshooting history module 600 retrieves one or more target metrics for replacing the code library under evaluation from the replacement metrics database 610 and generates a ranked list of the candidate code libraries according to how well each candidate code library satisfies the target metric(s).

With reference to FIG. 7, this figure depicts a block diagram of an exemplary code history module code history module 700 in accordance with an illustrative embodiment. In an exemplary embodiment, the code history module 700 is an example of the code history module 700 of FIG. 3.

In the illustrated embodiment, the code history module 700 includes a modification evaluation module 702, an NLP module 704, a library detection module 706, and a context detection module 708. The code history module 700 is in communication with a replacement metrics database 710, which may include local and/or remote data storage. In alternative embodiments, the code history module 700 can include some or all of the functionality described herein but grouped differently into one or more modules. In some embodiments, the functionality described herein is distributed among a plurality of systems, which can include combinations of software and/or hardware based systems, for example Application-Specific Integrated Circuits (ASICs), computer programs, or smart phone applications.

In the illustrated embodiment, the code history module 700 is a software module that consumes data from code management cloud services (e.g., generally illustrated as code management system 310 of FIG. 3). In some embodiments, the code history module 700 accesses the code management cloud services to execute the querying process that searches for candidate code libraries to replace a current library in an original software application. In some embodiments, the code history module 700 retrieves replacement metrics from the replacement metrics database 710 to use for evaluating and ranking candidate code library replacements found by the querying process.

In the illustrated embodiment, the modification evaluation module 702 receives information regarding the code library being evaluated from the library management server 306 of FIG. 3. In some embodiments, the modification evaluation module 702 conducts a search of one or more code management systems for the code library being evaluated. In some embodiments, the modification evaluation module 702 conducts a search of one or more public and/or private code management systems according to a predetermined list of code management systems. For example, in some embodiments, the modification evaluation module 702 conducts a search of one or more source code repositories that are publicly accessible via the Internet. Each time the modification evaluation module 702 finds source code that includes the code library being evaluated, the modification evaluation module 702 evaluates the source code to detect whether the source code has been modified to replace the code library being evaluated with another code library that could potentially be a candidate code library for replacing the code library being evaluated. If so, the modification evaluation module 702 sends information about the source code and the candidate code library to the NLP module 704. In response, the NLP module 704 processes the information in conjunction with the library detection module 706 and the context detection module 708. The library detection module 706 uses the NLP module 704 to identify a candidate replacement library in the information, which may include the source code and/or discussions regarding the source code. The context detection module 708 uses the NLP module 704 to confirm that the information includes a code change or other type of description of a library change to implement the candidate code library. In some embodiments, the context detection module 708 also detects information regarding changes to metrics achieved by implementing the candidate code library and stores this information associated with the candidate code library in the replacement metrics database 710.

In some embodiments, the code history module 700 outputs each candidate code library for library migration, for example to the library replacement module 318 of FIG. 3. In some embodiments, the code history module 700 retrieves one or more target metrics for replacing the code library under evaluation from the replacement metrics database 710 and generates a ranked list of the candidate code libraries according to how well each candidate code library satisfies the target metric(s).

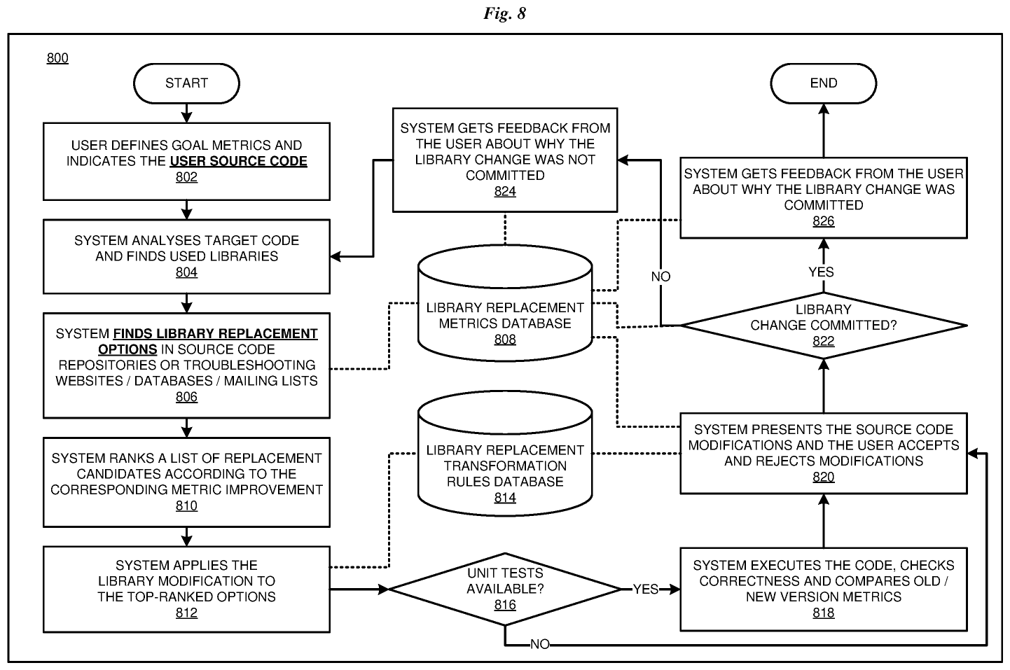

With reference to FIG. 8 this figure depicts a flowchart of an example code library selection management process 800 in accordance with an illustrative embodiment. In a particular embodiment, the library management server 306 of FIG. 3 carries out the code library selection management process 800.

At 802, the process 800 allows a user to define target code to be analyzed and one or more goal metrics. Examples of metrics include execution costs, maintenance costs, resources consumed during execution, storage requirements, and financial costs (e.g., licenses). In some embodiments, these metrics are used to compare the target code being analyzed to candidate code libraries.

At 804, the process 800 analyzes the code specified in 802 to find libraries that could be replaced.

At 806, the process 800 analyzes library replacement options based on the libraries identified at 804. In some embodiments, at 806 the process investigates replacement options and identifies candidate code libraries from code repositories and other sources of information, such as troubleshooting websites, databases, and mailing lists. In some embodiments, at 806 the process 800 produces a list of candidate code libraries. In some embodiments, at 806 the process 800 stores information regarding the candidate code libraries in a library replacement metrics database 808. In some embodiments, the process 800 also determines the corresponding potential improvement of the relevant metrics for each of the candidate code libraries applied based on the metrics provided by the user at 802.

At 810, the process 800 presents the list of candidate code libraries to the user. In some embodiments, the process 800 also presents the corresponding potential improvement of the relevant metrics if the replacement was applied based on the metrics provided by the user at 802. In some embodiments, the process 800 generates a ranked list of the set of candidate code libraries according to how well each candidate code library of the set of candidate code libraries satisfies the predetermined metric and presents the ranked list to the user. Alternatively, in some such embodiments, the process 800 selects the highest ranking one of the candidate code libraries for modification.

At 812, the process 800 modifies the source code to implements candidate code library selected at 810. In some embodiments, the process 800 modifies the source code to implements candidate code library based on transformation rules specified in a database 814.

At 816, the process 800 detects if unit tests are available. If so, the process 800 executes these tests at 818. If tests are not available, the process 800 proceeds to 820.

At 818, the process 800 executes the unit tests and code in order to evaluate correctness and produce new measurements of the metrics specified in 802. With the new measurements, the process 800 compares the old and the new versions of the source code.

At 820, the process 800 presents a modification report to the modifications with information regarding changes made to the source code to accommodate the candidate code library. At 822, the process 800 detects whether the user decides to accept or reject the proposed replacement. If the user does not accept the changes, the process continues to 824 where the process requests feedback from the user regarding the decision not to accept the changes. Otherwise, if the user does accept the changes, the process continues to 826 where the process requests feedback from the user regarding the decision to accept the changes. In some embodiments, the process 800 stores the feedback received at 824 or 826 in the library replacement transformation rules database.

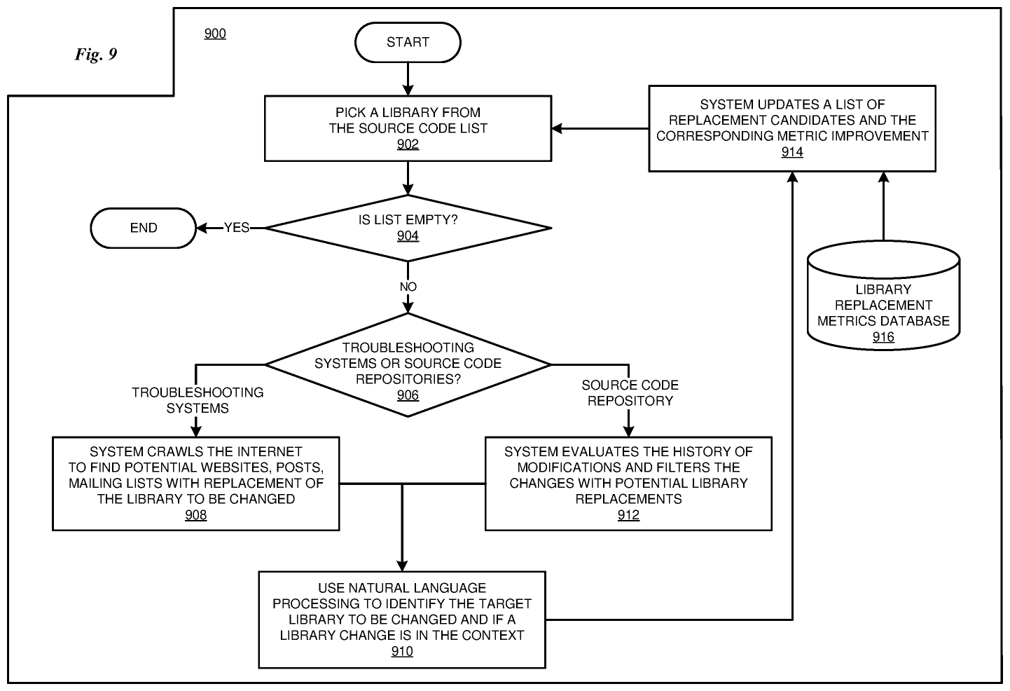

With reference to FIG. 9 this figure depicts a flowchart of an example querying process 900 in accordance with an illustrative embodiment. In a particular embodiment, the library management server 306 of FIG. 3 carries out the code library selection management process 800 using the troubleshooting history module 322 and/or code history module 324 of FIG. 3.

At 902, the process 900 or the user selects replacement candidate library from the source code list. At 904, the process 900 the list is empty, the process ends. Otherwise, the process 900 continues to 906. At 906, if the candidate code library comes from a source code repository, the process 900 continues to 912. Otherwise, the process 900 continues to 908. At 908, the process 900 crawls a designated network, for example websites, including posts, mailing lists, issue lists, to find candidate code libraries. At 910, the process 900 uses natural language processing to identify the target library to be replaced in code found either from the search at 908 or the code repository at 912. At 912, the process 900 evaluates the history of modifications to source code that has the candidate code library and filters the changes to include only those that are relevant to the candidate code library. At 914, the process 900 updates a list of candidate code libraries while determining the metric changes related to the candidate code library.

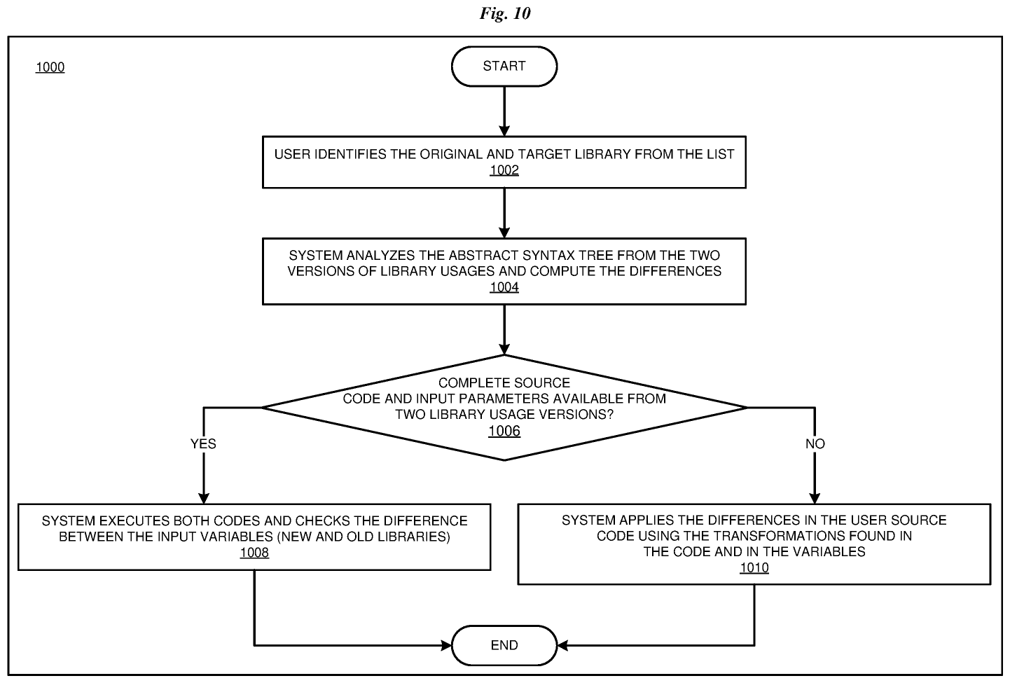

With reference to FIG. 10 this figure depicts a flowchart of an example library modification process 1000 in accordance with an illustrative embodiment. In a particular embodiment, the library replacement module 318 of FIG. 3 carries out the process 1000.

At 1002, the process 1000 allows a user to identify original and target libraries from a list. At 1004, the process 1000 analyzes abstract syntax trees from the original and target versions of the source code and computes the differences between the two versions of the source code. At 1006, the process 1000 determines whether complete source code and input parameters are available for each of the two versions of the source code. If a positive result is achieved at 1006, the process 1000 continues to 1008; otherwise, the process continues to 1010. At 1008, the process executes both versions of the source code and checks the differences between the input variable. At 1010, the process applies the differences in the source code using the transformations found in the code and in the variables.

The following definitions and abbreviations are to be used for the interpretation of the claims and the specification. As used herein, the terms “comprises,” “comprising,” “includes,” “including,” “has,” “having,” “contains” or “containing,” or any other variation thereof, are intended to cover a non-exclusive inclusion. For example, a composition, a mixture, process, method, article, or apparatus that comprises a list of elements is not necessarily limited to only those elements but can include other elements not expressly listed or inherent to such composition, mixture, process, method, article, or apparatus.

Additionally, the term “illustrative” is used herein to mean “serving as an example, instance or illustration.” Any embodiment or design described herein as “illustrative” is not necessarily to be construed as preferred or advantageous over other embodiments or designs. The terms “at least one” and “one or more” are understood to include any integer number greater than or equal to one, i.e., one, two, three, four, etc. The terms “a plurality” are understood to include any integer number greater than or equal to two, i.e., two, three, four, five, etc. The term “connection” can include an indirect “connection” and a direct “connection.”

References in the specification to “one embodiment,” “an embodiment,” “an example embodiment,” etc., indicate that the embodiment described can include a particular feature, structure, or characteristic, but every embodiment may or may not include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described.

The terms “about,” “substantially,” “approximately,” and variations thereof, are intended to include the degree of error associated with measurement of the particular quantity based upon the equipment available at the time of filing the application. For example, “about” can include a range of ±8% or 5%, or 2% of a given value.

The descriptions of the various embodiments of the present invention have been presented for purposes of illustration but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments described herein.

The descriptions of the various embodiments of the present invention have been presented for purposes of illustration but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments described herein.

Thus, a computer implemented method, system or apparatus, and computer program product are provided in the illustrative embodiments for managing participation in online communities and other related features, functions, or operations. Where an embodiment or a portion thereof is described with respect to a type of device, the computer implemented method, system or apparatus, the computer program product, or a portion thereof, are adapted or configured for use with a suitable and comparable manifestation of that type of device.

Where an embodiment is described as implemented in an application, the delivery of the application in a Software as a Service (SaaS) model is contemplated within the scope of the illustrative embodiments. In a SaaS model, the capability of the application implementing an embodiment is provided to a user by executing the application in a cloud infrastructure. The user can access the application using a variety of client devices through a thin client interface such as a web browser (e.g., web-based e-mail), or other light-weight client-applications. The user does not manage or control the underlying cloud infrastructure including the network, servers, operating systems, or the storage of the cloud infrastructure. In some cases, the user may not even manage or control the capabilities of the SaaS application. In some other cases, the SaaS implementation of the application may permit a possible exception of limited user-specific application configuration settings.

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus, or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

Embodiments of the present invention may also be delivered as part of a service engagement with a client corporation, nonprofit organization, government entity, internal organizational structure, or the like. Aspects of these embodiments may include configuring a computer system to perform, and deploying software, hardware, and web services that implement, some or all of the methods described herein. Aspects of these embodiments may also include analyzing the client's operations, creating recommendations responsive to the analysis, building systems that implement portions of the recommendations, integrating the systems into existing processes and infrastructure, metering use of the systems, allocating expenses to users of the systems, and billing for use of the systems. Although the above embodiments of present invention each have been described by stating their individual advantages, respectively, present invention is not limited to a particular combination thereof. To the contrary, such embodiments may also be combined in any way and number according to the intended deployment of present invention without losing their beneficial effects.

What is claimed is:

1. A processor-implemented method comprising:
executing a querying process that searches for candidate code libraries to replace a current library in an original software application;
receiving a search result from the querying process, wherein the search result includes a set of candidate code libraries;
identifying a top candidate code library as a highest ranking code library of the set of candidate code libraries based on predetermined metrics; and
generating a revised software application from the original software application, the generating comprising replacing the current library in the original software application with the top candidate code library.

2. The method of claim 1, further comprising:
analyzing source code of the original software application, the analyzing resulting in a list of code libraries referenced by the original software application.

3. The method of claim 1, wherein the querying process comprises searching a network for information associated with a change to source code to implement a first candidate code library of the set of candidate code libraries.

4. The method of claim 3, further comprising:
identifying, using natural language processing, the change to the source code to implement the first candidate code.

5. The method of claim 3, further comprising:
generating a first abstract syntax tree from a first version of the source code prior to the change;
generating a second abstract syntax tree from a second version the source code after the change; and
determining differences between the first abstract syntax tree and the second abstract syntax tree.

6. The method of claim 5, further comprising:
executing the first version of the source code as it existed before the change;
executing the second version of the source code as it existed after the change; and
compare processing of an input variable by the executing of the first version of the source code and the executing of the second version of the source code.

7. The method of claim 1, further comprising:
identifying source code that references a first candidate code library of the set of candidate code libraries; and
detecting an indication of an explanation of a change to the source code to implement the first candidate code.

8. The method of claim 7, further comprising:
identifying, using natural language processing, the change to the source code to implement the first candidate code.

9. The method of claim 1, further comprising:
generating a ranked list of the set of candidate code libraries according to how well each candidate code library of the set of candidate code libraries satisfies the predetermined metrics.

10. The method of claim 1, further comprising:
performing unit tests on the revised software application resulting in a first set of test results; and
comparing the first set of test results with a second set of test results resulting from testing of the original software application.

11. The method of claim 1, further comprising:
providing the revised software application to a user for review; and
receiving an indication of whether the user accepts the revised software application.

12. The method of claim 11, further comprising:
sending a feedback request to the user requesting a reason for the user's decision regarding whether to accept the revised software application.

13. A computer program product comprising one or more computer readable storage media, and program instructions collectively stored on the one or more computer readable storage media, the program instructions executable by a processor to cause the processor to perform operations comprising:
executing a querying process that searches for candidate code libraries to replace a current library in an original software application;
receiving a search result from the querying process, wherein the search result includes a set of candidate code libraries;
identifying a top candidate code library as a highest ranking code library of the set of candidate code libraries based on predetermined metrics; and
generating a revised software application from the original software application, the generating comprising replacing the current library in the original software application with the top candidate code library.

14. The computer program product of claim 13, wherein the stored program instructions are stored in a computer readable storage device in a data processing system, and wherein the stored program instructions are transferred over a network from a remote data processing system.

15. The computer program product of claim 13, wherein the stored program instructions are stored in a computer readable storage device in a server data processing system, and wherein the stored program instructions are downloaded in response to a request over a network to a remote data processing system for use in a computer readable storage device associated with the remote data processing system, further comprising:
program instructions to meter use of the program instructions associated with the request; and
program instructions to generate an invoice based on the metered use.

16. The computer program product of claim 13, further comprising:
analyzing source code of the original software application, the analyzing resulting in a list of code libraries referenced by the original software application.

17. The computer program product of claim 13, wherein the querying process comprises searching a network for information associated with a change to source code to implement a first candidate code library of the set of candidate code libraries.

18. A computer system comprising a processor and one or more computer readable storage media, and program instructions collectively stored on the one or more computer readable storage media, the program instructions executable by the processor to cause the processor to perform operations comprising:
executing a querying process that searches for candidate code libraries to replace a current library in an original software application;
receiving a search result from the querying process, wherein the search result includes a set of candidate code libraries;
identifying a top candidate code library as a highest ranking code library of the set of candidate code libraries based on predetermined metrics; and
generating a revised software application from the original software application, the generating comprising replacing the current library in the original software application with the top candidate code library.

19. The computer system of claim 18, further comprising:
analyzing source code of the original software application, the analyzing resulting in a list of code libraries referenced by the original software application.

20. The computer system of claim 18, wherein the querying process comprises searching a network for information associated with a change to source code to implement a first candidate code library of the set of candidate code libraries.
